(19) United States
(12) Patent Application Publication
(10) Pub. No.: US 2024/0330522 A1
(43) Pub. Date: Oct. 3, 2024

(54) STREAMLINED PROGRAMMING OF LIGHTING SEQUENCE OF OPERATION

(71) Applicant: ABL IP HOLDING LLC, Conyers, GA (US)

(72) Inventors: Rangan Bharath, Conyers, GA (US); Alan David Sanders, Atlanta, GA (US); Scott R. Drake, Wallingford, CT (US)

(21) Appl. No.: 18/127,829

(22) Filed: Mar. 29, 2023

(51) Int. Cl. G06F 30/13; G06F 30/12

(52) U.S. Cl. CPC G06F 30/13; G06F 30/12; G06F 2111/02; H05B 47/165

(57) ABSTRACT

A method includes generating, via a lighting system design software on a computing device, a layout to place lighting system elements in a floorplan of a building. The method further includes specifying, via the lighting system design software, a lighting sequence of operation for behaviors of the lighting system elements. The method further includes transmitting the layout and the lighting sequence of operation over a network to a provisioning device or a gateway/edge device. The method further includes programming settings for the lighting system elements based on the lighting sequence of operation. The method can optionally include assigning, via the provisioning device, network addresses to the lighting system elements based on the layout. The step of programming settings for the lighting system elements can further be based on the assigned network addresses.

### BACKGROUND

Building plans, which include the floorplans, but can also include the physical models of the materials and system components which are planned, are often used in conjunction with lighting system design software. For example, floorplans can be obtained from an electrical specifier or engineer in the form of construction documents that show lighting systems, electrical systems, etc., which are then used to layout the design of those systems.

The lighting system design software is then used to place (or layout) lighting system elements, such as luminaires, lighting control devices, and sensors for the building based on an architect's guidance and system specifications. Lighting sequence of operations (SOO) are often planned in the lighting system design software and the deliverable coming out of the lighting system design software is a printed lighting controls plan document. That lighting controls plan document is then relayed to a technician setting up the lighting system in a paper or written form. The technician then follows the directions in the lighting controls plan document to program the lighting system elements in the building.

In one example, a technician takes the lighting sequence of operations and translates that into different settings for the lighting system elements by manipulating the lighting system elements one by one. During commissioning, the technician may select a luminaire and assign the luminaire a particular network address. The technician then reads the lighting controls plan document, which can include group/zone information for the luminaires, and then manipulates lighting control devices and sensors to transcribe lighting behavior onto the luminaires.

A streamlined programming protocol is needed to overcome these and other limitations in the art.

### SUMMARY

Techniques are described herein relating to a streamline programming protocol 200 of the lighting system elements 104A-X of a lighting system 100. The streamlined programming protocol 200 described herein can automatically take a layout 103 from a lighting system design software 101 to a wide area network 530 (e.g., cloud) in order to automatically program the lighting system elements 104A-X without a technician having to manually adjust settings on each individual lighting system element 104A-X.

In a first example, a method includes generating, via a lighting system design software 101 on a computing device 102, a layout 103 to place lighting system elements 104A-X in a floorplan 105 of a space 120, such as a building. In one example, the layout 103 can be spatial, e.g., X-Y coordinates. The method further includes specifying, via the lighting system design software 101, a lighting sequence of operation 106 for behaviors 115A-X of the lighting system elements 104A-X. The method further includes transmitting the layout 103 and the lighting sequence of operation 106 over a network 108 to a provisioning device 107 or a gateway/edge device 520. The method further includes programming settings 138A-X for the lighting system elements 104A-X based on the lighting sequence of operation 106.

In a second example, a non-transitory machine-readable medium includes streamlined programming 284A-C in a memory 283 of one or more computing devices 102, 566 configured to store therein instructions to program settings 138A-X for one or more lighting system elements 104A-X. Execution of the streamlined programming 284 by a processor 282 configures the one or more computing devices 102, 566 to implement the following functions. The one more computing devices 102, 566 generate, via a lighting system design software 101 on a computing device 102, a layout 103 to place lighting system elements 104A-X in a floorplan 105 of a space 120, such as a building. The one more computing devices 102, 566 specify, via the lighting system design software 101, a lighting sequence of operation 106 for behaviors 115A-X of the lighting system elements 104A-X. The one more computing devices 102, 566 transmit the layout 103 and the lighting sequence of operation 106 over a network 108 to a provisioning device 107 or a gateway/edge device 520.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 depicts a lighting system that includes a computing device with lighting system design software and a provisioning device to automatically program lighting system elements.

FIG. 2 is a streamlined programming protocol for the lighting system that is implemented by the computing device, provisioning device, and lighting system elements.

FIG. 3 depicts the provisioning device being carried through a space, such as a building, including a plurality of different rooms, during the streamlined programming protocol.

FIG. 4 is a schematic of the lighting system of FIGS. 1-3 that includes a visual layout of a plurality of luminaires as represented by a respective set of location coordinates.

FIG. 5 is a high-level functional block diagram of another example of the lighting system of luminaires, networks, and other computing devices; and the provisioning device designed to implement the streamlined programming protocol.

### PARTS LISTING

100 Lighting System
101 Lighting System Design Software
102 Computing Device
103 Layout
104A-X Lighting System Elements
105 Floorplan
106 Lighting Sequence of Operation
107 Provisioning Device
108 Network
115A-X Behaviors
120 Space
121A-P Luminaires
122A-D Lighting Control Devices
123A-D Occupancy, Daylight, or Audio Sensors
130 Memory
131 Processor
132 Network Communication Interface
133 Driver Circuit
134 Illumination Light Source
135 Illumination Lighting
137A-X Network Addresses
138A-X Settings
140 MCU
146 Switches or Touch Screen Display
155 Drive/Sense Circuitry
156 Detectors
200 Streamlined Programming Protocol
281 Network Communication Interface
282 Processor
283 Memory
284A-C Streamlined Programming
291 Network Communication Interface
292 Processor
293 Memory
295 Provisioning Application
300A-B Location
301A-B Room
305A-B Group/Zone
310 Tag Code
427A-P Location Coordinates
498A-B Physical Location
500 Lighting System
507 Provisioning Network
508 LAN
520 Gateway/Edge Device
530 WAN
566 Cloud Computing Device

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The term “luminaire,” as used herein, is intended to encompass essentially any type of device that processes energy to generate or supply artificial light, for example, for general illumination of a space intended for use of occupancy or observation, typically by a living organism that can take advantage of or be affected in some desired manner by the light emitted from the device. However, a luminaire may provide light for use by automated equipment, such as sensors/monitors, robots, etc. that may occupy or observe the illuminated space, instead of or in addition to light provided for an organism. However, it is also possible that one or more luminaires in or on a particular premises have other lighting purposes, such as signage for an entrance or to indicate an exit. In most examples, the luminaire(s) illuminate a space or area of a premises to a level useful for a human in or passing through the space, e.g., of sufficient intensity for general illumination of a room or corridor in a building or of an outdoor space such as a street, sidewalk, parking lot or performance venue. The actual source of illumination light in or supplying the light for a luminaire may be any type of artificial light emitting device, several examples of which are included in the discussions below.

The term “lighting system,” as used herein, is intended to encompass essentially any type of system that either includes a number of such luminaires coupled together for data communication and/or luminaire(s) coupled together for data communication with one or more control devices, such as wall switches, control panels, remote controls, central lighting or building control systems, servers.

Terms such as “artificial lighting” or “illumination lighting” as used herein, are intended to encompass essentially any type of lighting that a device produces light by processing of electrical power to generate the light. A luminaire for an artificial lighting or illumination lighting application, for example, may take the form of a lamp, light fixture, or other luminaire arrangement that incorporates a suitable light source, where the lighting device component or source(s) by itself contains no intelligence or communication capability. The illumination light output of an artificial illumination type luminaire, for example, may have an intensity and/or other characteristic(s) that satisfy an industry acceptable performance standard for a general lighting application.

The term “coupled” as used herein refers to any logical, optical, physical or electrical connection, link or the like by which signals or light produced or supplied by one system element are imparted to another coupled element. Unless described otherwise, coupled elements or devices are not necessarily directly connected to one another and may be separated by intermediate components, elements or communication media that may modify, manipulate or carry the light or signals

Reference now is made in detail to the examples illustrated in the accompanying drawings and discussed below.

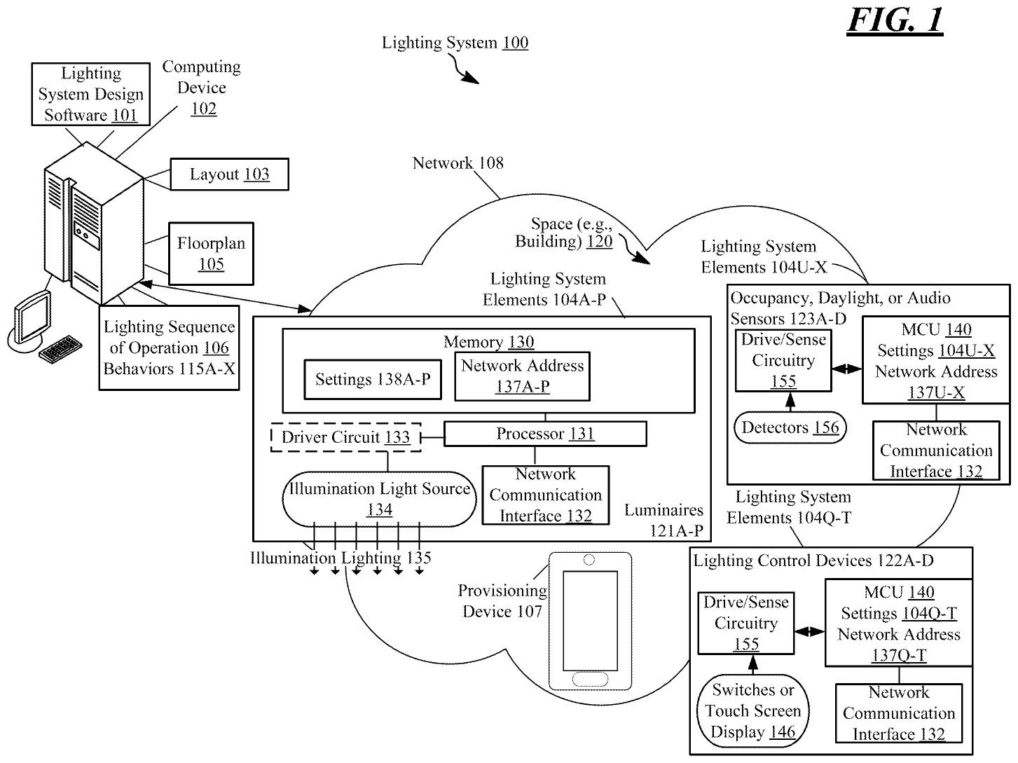

FIG. 1 depicts a lighting system 100 that includes a computing device 102 with lighting system design software 101 and a provisioning device 107 to automatically program lighting system elements 104A-X. Lighting system 100 is designed with the lighting system design software 101 on the computing device 102 to specify lighting behaviors 115A-X of a lighting sequence of operation 106. Lighting sequence of operation 106 can be uploaded to a network 108 (e.g., cloud) or loaded into a provisioning application 295 to program the lighting system elements 104A-X during provisioning. Alternatively, or additionally, the lighting system elements 104A-X can be programmed during or at any time after provisioning via streamlined programming 184. The streamlined programming 184 automatically programs lighting system elements 104A-X according to the behaviors 115A-X in the lighting sequence of operation 106.

Provisioning device 107 of a user (e.g., a human or a robot) can be any computing device, such as a smartphone, tablet computing device, wearables (e.g., hearing aid, Google Glass, smart watch, or implantables), or laptop/personal computing device. The provisioning device 107 automatically propagates the lighting behaviors 115A-X of the lighting sequence of operation 106 to respective lighting system elements 104A-X during provisioning, for example.

Lighting system elements 104A-X of the lighting system 100 are located in a space 120, such as a building. In the example, lighting system elements 104A-P are luminaires 121A-P; lighting system elements 104Q-T are lighting control devices 122A-D; and lighting system elements 104A-U-X are occupancy, daylight, or audio sensors 123A-D. Luminaires 121A-X illuminate the space 120 of a premises to a level useful for a human in or passing through the space 120, e.g. general illumination of the space 120, such as a warehouse, room, or a corridor in a building; or of an outdoor space such as a street, sidewalk, parking lot or performance venue. Lighting control devices 122A-D can be wall switches or touch screen devices to turn on/off or dim luminaires 121A-X. Occupancy, daylight, or audio sensors 123A-D can enable controls for on/off, occupancy, and dimming of the luminaires 121A-P.

As shown, luminaires 121A-P include an illumination light source 134 to emit illumination lighting 135 for the space 120; and an optional driver circuit 133 coupled to the illumination light source 134 to control operation of the illumination light source 134. In some examples, the luminaires 121A-P may include a ballast instead of the driver circuit 133 depending on the type of illumination light source 134 (e.g., for a fluorescent or incandescent light bulb).

Luminaires 121A-P further include a network communication interface 132 configured for wireless or wired communication, for example, over the network 108. The luminaires 121A-P further include a memory 130; and a processor 131 coupled to the network communication interface 132 and the memory 130. The luminaires 121A-X further include respective settings 138A-X stored in the memory 130 that are programmed based on behaviors 115A-X specified in the lighting sequence of operation 106. Behaviors 115A-X describe the desired characteristics of operation for the lighting system elements 104A-X and are translated into settings 138A-X (how to actually accomplish the behaviors 115A-X) by the streamlined programming 184B.

In addition, the luminaires 121A-X further include a respective network address 137A-P stored in the memory 130, which may be assigned during provisioning by the provisioning device 107. As shown, each of the occupancy, daylight, and audio sensors 123A-D includes an on-board micro-control unit (MCU) 140 that includes a memory (volatile and non-volatile) and a central processing unit (CPU). Occupancy, daylight, or audio sensors 123A-D have the MCU 140 coupled to drive/sense circuitry 155 operable to control detectors 156 and a network communication interface 132. The memory of the MCU 140 of the occupancy, daylight, or audio sensors 123A-D stores respective settings 104U-X and network addresses 137U-X.

The circuitry, hardware, and software of the lighting control devices 122A-D shown are similar to the occupancy, daylight, or audio, sensors 123A-D. Lighting control devices 122A-D can be a wall switch where the drive/sense circuitry 155 responds to switches 146. Switches 146 can be an on/off switch, dimmer switch, or set scene. Switches 146 can be a single shared button switch for on/off, dimming, or set scene functions. A button station can include various button settings that can have the lighting control settings adjusted, for example, four buttons can be arranged with two longitudinal buttons (north-south) and two lateral buttons (east-west). Alternatively, lighting control devices 122A-D can be a touchscreen device in which lighting control setting adjustments are inputted via a user interface application (not shown) through manipulation or gestures on a touch screen display 146. As shown, the memory of the MCU 140 of the lighting control devices 122A-D stores respective settings 104Q-T and network addresses 137Q-T.

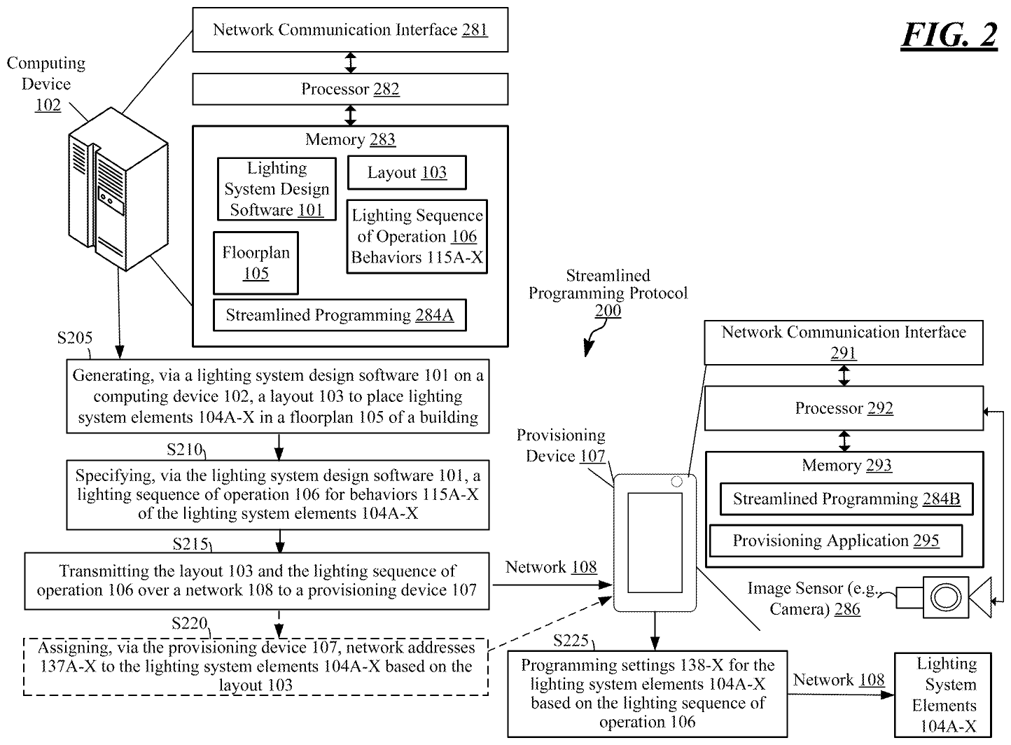

FIG. 2 is a streamlined programming protocol 200 for the lighting system 101 that is implemented by the computing device 102, provisioning device 107, and lighting system elements 104A-X. Streamlined programming protocol 200 enables the lighting sequence of operation 106 created in the lighting system design software 101 to automatically program the lighting system elements 104A-X with behaviors 115A-X.

In the example of FIG. 2, the streamlined programming protocol 200 is implemented in the streamlined programming 284A of the computing device 102 and the streamlined programming 284B of the provisioning device 107. Execution of streamlined programming 284A stored in a memory 283 by a processor 282 of the computing device 102 causes the computing device 102 to implement blocks S205, S210, S215, and S220 described below. Execution of streamlined programming 284B stored in a memory 293 by a processor 292 of the provisioning device 107 causes the provisioning device 107 to implement block S225 described below.

Beginning in block S205, the streamlined programming protocol 200 includes generating, via the lighting system design software 101 on a computing device 102, a layout 103 to place lighting system elements 104A-X in a floorplan 105 of a building. Continuing to block S210, the streamlined programming protocol 200 further includes specifying, via the lighting system design software 101, a lighting sequence of operation 106 for behaviors 115A-X of the lighting system elements 104A-X.

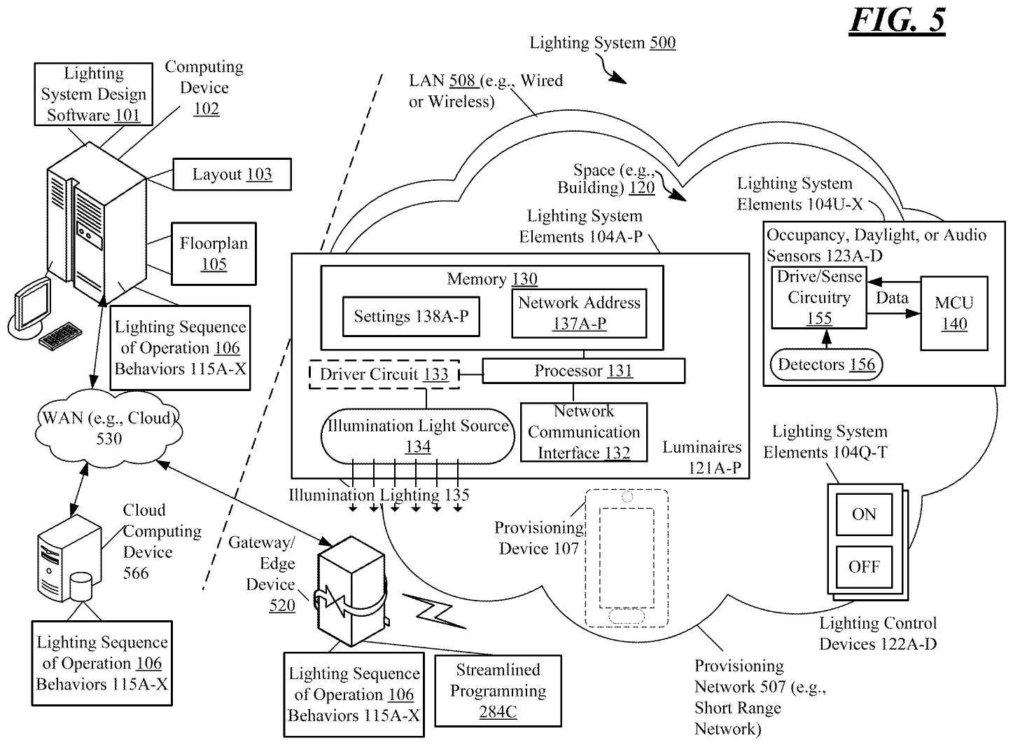

Moving now to block S215, the streamlined programming protocol 200 further includes transmitting the layout 103 and the lighting sequence of operation 106 over a network 108 to a provisioning device 107 or a gateway/edge device 520 (see FIG. 5). The network 108 can be a wired or wireless network. Computing device 102 can transmit the layout 103, via a network communication interface 281, to the provisioning device 107, for example.

Finishing now, in block S225, the streamlined programming protocol 200 further includes programming settings 138A-X for the lighting system elements 104A-X based on the lighting sequence of operation 106. The block S225 of programming the settings 138A-X for the lighting system elements 104A-X based on the lighting sequence of operation 106 can be implemented via the provisioning device 107. Hence, the provisioning device 107 receives the layout 103, via a network communication interface 291, from the computing device 102.

Proceeding to optional block S220, streamlined programming protocol 200 can further include assigning, via the provisioning device 107, network addresses 137A-X to the lighting system elements 104A-X based on the layout 103. The block S225 of programming settings 138A-X for the lighting system elements 104A-X can be further based on the assigned network addresses 137A-X.

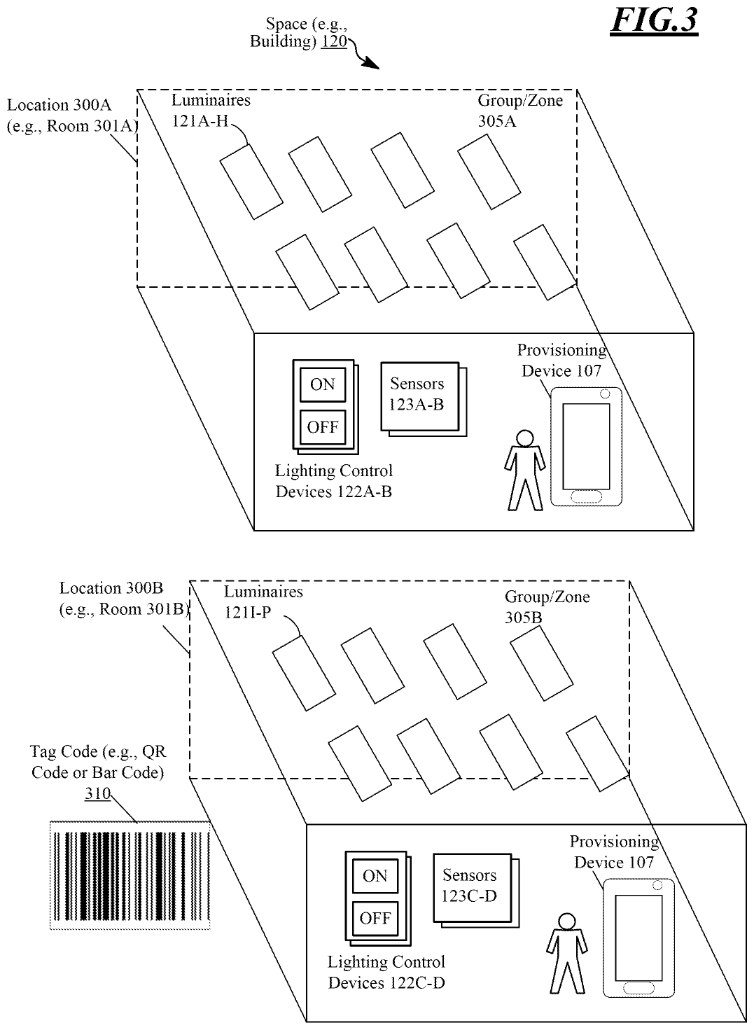

FIG. 3 depicts the provisioning device 107 being carried through the space 120, including a plurality of different rooms 301A-B, during the streamlined programming protocol 200. As shown, the provisioning device 107 is carried in various locations 300A-B in the space 120. In the example of FIG. 3, the locations 300A-B include two different rooms 301A, 301B. A first room 301A includes luminaires 121A-H, lighting control devices 122A-B, and occupancy, daylight, or audio sensors 123A-B. A second room 301B includes luminaires 121I-P, lighting control devices 122C-D, and occupancy, daylight, or audio sensors 123C-D. Accordingly, in the streamlined programming protocol 200, the assigned network addresses 137A-X can be tied to locations 300A-B of the lighting system elements 104A-X in the layout 103.

Execution of streamlined programming 284B stored in the memory 293 by the processor 292 of the provisioning device 107 causes the provisioning device 107 to implement the following steps of the streamlined programming protocol 200. In a first example, streamlined programming protocol 200 can further include grouping, via the provisioning device 107, the lighting system elements 104A-X into one or more groups/zones 305A-B based on the layout 103. Hence, the step S225 (see FIG. 2) of programming the settings 138A-X for the lighting system elements 104A-X can be further based on the one or more groups/zones 305A-B. In a second example, the step of programming the settings 138A-X for the lighting system elements 104A-X can further include the following. First, scanning a tag code 310 (e.g., quick response code or bar code), such as on a label of the lighting system elements 104A-X, to tie the lighting system elements 104A-X to lighting system element types and locations 300A-B. Second, transcribing the behaviors 115A-X into the settings 138A-X of the lighting system elements 104A-X based on the lighting system element types and locations 300A-B. As used herein, “lighting system element types” means whether the lighting system element 104A-X is a luminaire, lighting control device; occupancy, daylight, or audio, sensor; etc.

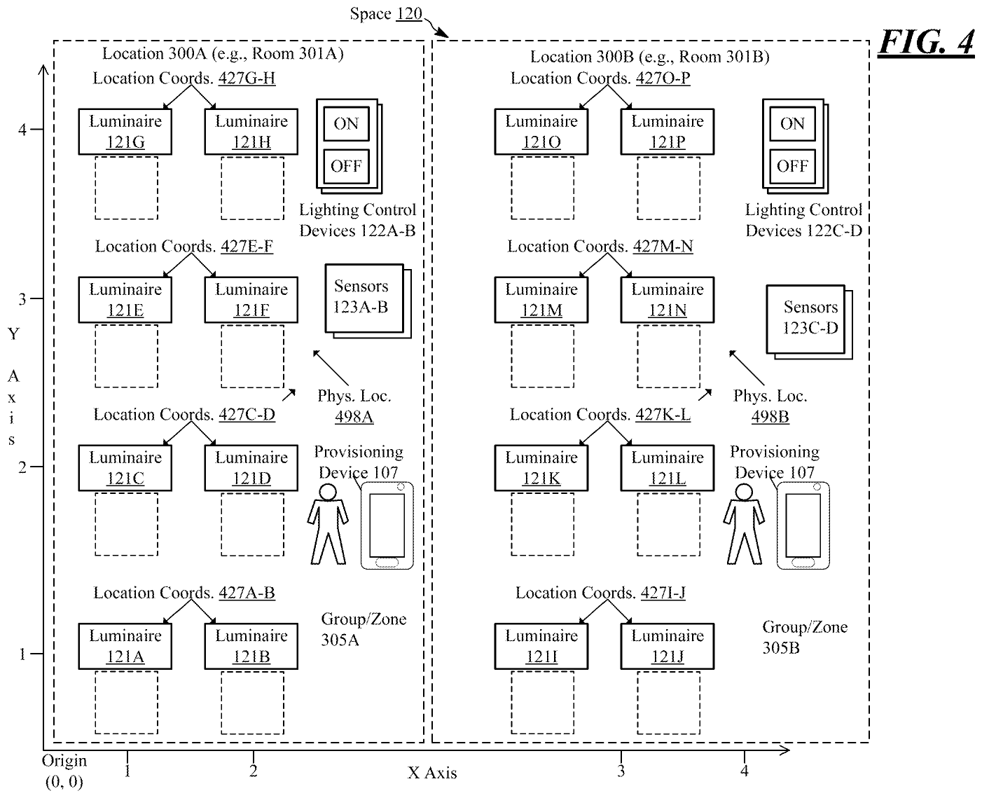

FIG. 4 is a schematic of the lighting system 100 of FIGS. 1-3 that includes a visual layout of a plurality of luminaires 121A-P as represented by a respective set of location coordinates 427A-P. Locations 300A-B of the luminaires 121A-P and other lighting system elements 104Q-X can be defined for room level programming. Alternatively or additionally, locations 300A-B can be defined on a more granular basis, such as location coordinates 427A-P in the space 120, to know exactly where the lighting system elements 104A-X are positioned in the rooms 301A-B. Yet alternatively, the rooms 301A-B may subdivide into two sides so the location coordinates 427A-P may be more specific to each room 301A-B, but not completely specific to each luminaire 121A-P. The granularity of the locations 300A-B can depend on the lighting behaviors 115A-X specified in the lighting sequence of operation 106.

As shown, the respective set of location coordinates 427A-P are located on a two-dimensional Cartesian coordinate system, which includes an X axis for horizontal (e.g., lateral) coordinate position and a Y axis for a vertical coordinate position (e.g., longitudinal). An X location coordinate component of the respective set of location coordinates 427A-P ranges from 1 to 4 in the example, and the Y location coordinate component of the respective set of location coordinates 127A-P ranges from 1 to 4. The X location coordinate and the Y location coordinate cover the entire floor area of the space 120, which maps each of the luminaires 121A-X to more specific areas of each room 301A-B.

In FIG. 4, eight luminaires 121A-H, two lighting control devices 122A-B, and two occupancy, daylight, or audio sensors 123A-B form a first group/zone 305A located in a first room 301A that forms a first group/zone 305A. Lighting control devices 122A-B and sensors 123A-B control all of the luminaires 121A-H in the first room 301A.

As further shown, eight other luminaires 1211-P, two other lighting control devices 122C-D, and two other occupancy, daylight, or audio sensors 123C-D form a second group/zone 305B located in a second room 301B. Lighting control devices 122C-D and sensors 123C-D control all of the luminaires 1211-P in the second room 301B. Hence, each group/zone 305A-B includes a respective plurality of member lighting system elements 104A-L (twelve members each).

In the example of FIGS. 1-4, lighting system elements 104A-X, such as luminaires 121A-P, lighting control devices 122A-D, and sensors 123A-D can communicate with the provisioning device 107 of the user to determine a physical location 498A-B of the lighting system elements 104A-X in the space 120. Based on the determined physical location 49A-B, the luminaires 121A-P, lighting control devices 122A-D, and sensors 123A-D can be assigned to a group/zone 305A-B to receive respective behaviors 115A-X of a lighting sequence of operation 106 for a corresponding room 301A-B.

During operation, luminaires 121A-P, lighting control devices 121A-D, and sensors 123A-D are installed and controls are propagated using streamlined programming 184A-B. Computing device 102 and provisioning device 107 executing streamlined programming 184A-B can connect over the network 108 to all of the lighting system elements 104A-X in rooms 301A-B. Streamlined programming 184A-B implements the streamlined programming protocol 200 to enable the lighting sequence of operation 106 from the lighting system design software 101 to automatically propagate from the computing device 102 to the provisioning device 107 to automatically program the lighting system elements 104A-X via the network 108. Streamlined programming 184A-B can take the group/zone 305A-B information and the lighting behaviors 115A-X of the lighting sequence of operation 106 and translate that information into settings 138A-X for lighting system elements 104A-X.

Lighting system design software 101 is used to design the lighting sequence of operation 106, which describes how the space 120 operates and lighting behaviors 115A-X of lighting system elements 104A-X located in the rooms 301A-B in the space 120. In one example, such as a space 120 (e.g., office space) having a first room 301A, the lighting sequence of operation 106 may include behaviors 115A-H that the luminaires 121A-H are manually turned on and automatically turned off by the occupancy sensor 123A-B within 15 minutes of an occupant leaving the first room 301A of the space 120. The lighting sequence of operation 106 can translate into different behaviors 115A-X for all of the lighting system elements 104A-X in the space 120. In another example, the behaviors 115I-P can specify to dim down the luminaires 1211-P located in the second room 301B of the space 120 based on a time of day or specify photocell, daylighting, and schedules for the luminaires 1211-P of the second group/zone 305B located in the second room 300B. The behaviors 115A-X can be dictated by energy code requirements.

Digitizing the lighting sequence of operation 106 and propagating the included behaviors 115A-X to lighting system elements 104A-X streamlines controls of the lighting system 100. Initially, an electrical engineer may create a lighting floorplan 105. Then, a designer can use the lighting system design software 101 to design the lighting sequence of operation 106 for the lighting system elements 104A-X based on the capabilities available in the lighting system elements 104A-X.

Initially, the lighting system elements 104A-X may not know which of the other lighting system elements 104A-X are near and in the same room 301A-B. Hence, the user can utilize the provisioning device 107 and associated provisioning application 295 to find uncommissioned luminaires 121A-P, lighting control devices 122A-D, and occupancy, daylight, or audio sensors 123A-D; add them to the space 120; and exchange encryption keys. The user specifies with the provisioning application 295 that luminaires 121A-H are in same room 301A along with lighting control devices 122A-B and sensors 123A-B. Then the provisioning application 285 groups luminaires 121A-H into group/zone 305A together to act at the same time, as well as assigns lighting control devices 122A-B and sensors 123A-B to the group/zone 305A.

The provisioning application 295 may tie network addresses 137A-X of the lighting system elements 104A-X to the layout 103 based on the floorplan 105 so a gateway/edge device 520 (see FIG. 5) later knows where the lighting system elements 104A-X are located. Provisioning application 295 can also tie the network addresses 137A-X to location coordinates 427A-X (see FIG. 4).

After commissioning and assigning luminaires 121A-H, lighting control devices 122A-B, and sensors 123A-B to the group/zone 305A, the streamlined programming 284B programs the lighting sequence of operation 106 and the included behaviors 115A-H into the luminaires 121A-H. Streamlined programming 284B also programs the lighting control devices 122A-B with behaviors 115Q-R, and sensors 123A-B with behaviors 115U-V over the network 108.

Similarly, provisioning programming 285 finds and groups luminaires 121I-P into group/zone 305B together to act at the same time, as well as assigns lighting control devices 122C-D and sensors 123C-D to the group/zone 305B. After assigning these devices to the group/zone 305B, the streamlined programming 284B programs the lighting sequence of operation 106 and the included behaviors 115A-H into the luminaires 1211-P. Streamlined programming 284B also programs the lighting control devices 122C-D with behaviors 115S-T. and sensors 123C-D with behaviors 115W-X over the network 108.

Behaviors 115A-X are programmed as settings 138A-X by the streamlined programming 184B after provisioning and after grouping the lighting system elements 104A-X together as appropriate. The layout 103 offers the opportunity to tie specific variation in the behaviors 115A-X of the lighting sequence of operation 106 to not just knowing the luminaires 121A-H are just in room 301A but in one specific spot near a door. For example, if the room 301A is a classroom and the space 120 is a school, then luminaires 121A-B may be near a chalkboard or whiteboard. The behaviors 115A-B for luminaires 121A-B may specify to dim the luminaires 121A-B to a lower level than luminaires 121C-H so that luminaires 121A-B behave as chalkboard or whiteboard lights. As another example, luminaires 121C-D may be near a window and are desired to be controlled by the daylight or occupancy sensor 123A. Finally, luminaries 121E-F may be in the middle of room 301A and behave as general lights so control is only by lighting control devices 122A-B. Knowing where the lighting system elements 104A-X are in the space 120, such as in room 301A, allows matching behaviors 115A-X to specific lighting system elements 104A-X that are tied to locations 300A-B, such as rooms 301A-B or specific location coordinates 427A-H.

At install time, the streamlined programming 284B can scan a tag code 310 (see FIG. 3) of the lighting system element 104A-X, e.g., a device label, a quick response (QR) code, etc. The tag code 310 can indicate what the network address 137A-X or serial no. is and that information is tied to the layout 103, e.g., a particular spot/location 300A-B, such as location coordinates 427A-H on the floorplan 105. Hence, streamlined programming 284B can use the tag code 310 of lighting system elements 104A-X combined with the layout 103 to translate behaviors 115A-X from the floorplan 105 to lighting system elements 104A-X. Eventually, the tag code 310 and network address 137A-X of the lighting system elements 104A-X can propagate to a gateway/edge device 520 (see FIG. 5) to support adjustments to the lighting sequence of operation 106 after provisioning. During the process of scanning the tag code 310, the streamlined programming 284B determines the appropriate settings 138A-X to send the lighting system elements 104A-X based on the behaviors 115A-X specified in the lighting sequence of operation 106.

FIG. 5 is a high-level functional block diagram of another example lighting system 500 of luminaires 121A-X; networks 507, 508, 530; other computing devices 520, 566; and the provisioning device 107. Lighting system 500 is designed to implement the streamlined programming protocol 200 in a somewhat different fashion than that shown in FIGS. 1-2. In the lighting system 500, information about the lighting sequence of operation 106 and the included lighting behaviors 115A-X is stored on a cloud computing device 566. Provisioning device 107 (e.g., mobile device and mobile application) is optional in the lighting system 500, but when present communicates with the lighting system elements 104A-X over a provisioning network 507, such as a short range wireless network and may further communicate with the gateway/edge device 520 via a local area network (LAN) 508.

Lighting system 500 can transfer the lighting sequence of operation 106 and associated lighting behaviors 115A-X at any time (not just during provisioning) through a gateway or an edge device 520 (referred to herein as “gateway/edge device” 520). Gateway/edge device 520 can execute streamlined programming 284C to receive the lighting sequence of operation 106 (e.g., new or updated) from a wide area network (WAN) 530 (e.g. cloud) from the computing device 102 or a separate cloud computing device 166. Upon receipt of the lighting sequence of operation 106 and the included lighting behaviors 115A-X, streamlined programming 284C executed by the gateway/edge device 520 can transmit the lighting behaviors 115A-X to respective lighting system elements 104A-X via a local area network (LAN) 508. The lighting behaviors 115A-X are applied as settings 138A-X to the lighting system elements 104A-X.

Any of the functionality of the streamlined programming protocol 200, including streamlined programming 284A-X and provisioning application 295, described herein for the computing device 102, lighting system elements 104A-X, provisioning device 107, gateway/edge device 520, cloud computing device 566, etc. can be embodied in one more applications or firmware as described previously. According to some embodiments, “function,” “functions,” “application,” “applications,” “instruction,” “instructions,” or “programming” are program(s) that execute functions defined in the programs. Various programming languages can be employed to create one or more of the applications, structured in a variety of manners, such as object-oriented programming languages (e.g., Objective-C, Java, or C++) or procedural programming languages (e.g., C or assembly language). In a specific example, a third-party application (e.g., an application developed using the ANDROID™ or IOS™ software development kit (SDK) by an entity other than the vendor of the particular platform) may be mobile software running on a mobile operating system such as IOS™, ANDROID™ WINDOWS® Phone, or another mobile operating system. In this example, the third-party application can invoke API calls provided by the operating system to facilitate functionality described herein.

In the examples above, the computing device 102, lighting system elements 104A-X, provisioning device 107, gateway/edge device 520, cloud computing device 566, etc. each include a processor. As used herein, a processor 131, 282, 292, is a hardware circuit having elements structured and arranged to perform one or more processing functions, typically various data processing functions. Although discrete logic components could be used, the examples utilize components forming a programmable central processing unit (CPU). A processor 131, 282, 292 for example includes or is part of one or more integrated circuit (IC) chips incorporating the electronic elements to perform the functions of the CPU.

The applicable processor 131, 282, 292 executes programming or instructions to configure the computing device 102, lighting system elements 104A-X, provisioning device 107, gateway/edge device 520, cloud computing device 566, etc. to perform various operations. For example, such operations may include various general operations (e.g., a clock function, recording and logging operational status and/or failure information) as well as various system-specific operations (e.g., daylighting and/or energy management) functions. Although a processor 131, 282, 292 may be configured by use of hardwired logic, typical processors in lighting devices or in light responsive devices are general processing circuits configured by execution of programming, e.g., instructions and any associated setting data from the memories 130, 283, 293 shown or from other included storage media and/or received from remote storage media.

In the examples above, the computing device 102, lighting system elements 104A-X, provisioning device 107, gateway/edge device 520, cloud computing device 566, etc. each include a memory. The memory 130, 283, 293 may include a flash memory (non-volatile or persistent storage), a read-only memory (ROM), and a random access memory (RAM) (volatile storage). The RAM serves as short term storage for instructions and data being handled by the processors 131, 282, 293 e.g., as a working data processing memory. The flash memory typically provides longer term storage.

Hence, a machine-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

In the examples above, the computing device 102, lighting system elements 104A-X, provisioning device 107, gateway/edge device 520, cloud computing device 566, etc. each include a network communication interface 132, 281, 291 for wired or wireless communication over one or more networks 108, 507, 508, and 530. The networks 108, 507, 508, and 530 interconnect the links to/from the network communication interfaces of the devices, so as to provide data communications amongst the computing device 102, lighting system elements 104A-X, provisioning device 107, gateway/edge device 520, and/or cloud computing device 566. Networks 108, 507, 508, and 530 may support data communication by equipment at the premises via wired (e.g. cable or fiber) media or via wireless (e.g. WiFi, Bluetooth, ZigBee, LiFi, IrDA, etc.) or combinations of wired and wireless technology.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain”, “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A method, comprising steps of:
generating, via a lighting system design software on a computer, a layout to place lighting system elements in a floorplan of a building;
specifying, via the lighting system design software, a lighting sequence of operation for behaviors of the lighting system elements;
transmitting the layout and the lighting sequence of operation over a network to a provisioning device or a gateway/edge device; and
programming settings for the lighting system elements based on the lighting sequence of operation.

2. The method of claim 1, further comprising:
assigning, via the provisioning device, network addresses to the lighting system elements based on the layout;
wherein the step of programming settings for the lighting system elements is further based on the assigned network addresses.

3. The method of claim 2, wherein:
the assigned network addresses are tied to locations of the lighting system elements in the layout.

4. The method of claim 2, wherein the locations include location coordinates.

5. The method of claim 1, wherein the locations include rooms.

6. The method of claim 1, further comprising:
grouping, via the provisioning device, the lighting system elements into one or more groups/zones based on the layout;
wherein the step of programming the settings for the lighting system elements is further based on the one or more groups/zones.

7. The method of claim 1, wherein the step of programming the settings for the lighting system elements further includes:
scanning a tag code on labels of the lighting system elements to tie the lighting system elements to lighting system element types and locations in the layout; and
transcribing the behaviors into the settings of the lighting system elements based on the lighting system element types and locations.

8. The method of claim 1, wherein the step of programming the settings for the lighting system elements based on the lighting sequence of operation is implemented via the provisioning device.

9. The method of claim 1, wherein the step of programming the settings for the lighting system elements based on the lighting sequence of operation is implemented via a gateway/edge device.

10. The method of claim 1, wherein the network is a wired or wireless network.

11. A non-transitory machine-readable medium, comprising:
streamlined programming, wherein execution of the streamlined programming by one or more processors configures one or more computing devices to:
generate, via a lighting system design software on a computer, a layout to place lighting system elements in a floorplan of a building;
specify, via the lighting system design software, a lighting sequence of operation for behaviors of the lighting system elements;
transmit the layout and the lighting sequence of operation over a network to a provisioning device or a gateway/edge device; and
program settings for the lighting system elements based on the lighting sequence of operation.

12. The non-transitory machine-readable medium of claim 11, wherein execution of the streamlined programming by the one or more processors configures the one or more computing devices to:
assign, via the provisioning device, network addresses to the lighting system elements based on the layout;
wherein the programming settings for the lighting system elements is further based on the assigned network addresses.

13. The non-transitory machine-readable medium of claim 12, wherein:
the assigned network addresses are tied to locations of the lighting system elements in the layout.

14. The non-transitory machine-readable medium of claim 12, wherein the locations include location coordinates.

15. The non-transitory machine-readable medium of claim 11, wherein the locations include rooms.

16. The non-transitory machine-readable medium of claim 11, wherein execution of the streamlined programming by the one or more processors configures the one or more computing devices to:
group, via the provisioning device, the lighting system elements into one or more groups/zones based on the layout;
wherein the programming the settings for the lighting system elements is further based on the one or more groups/zones.

17. The non-transitory machine-readable of claim 11, wherein the programming the settings for the lighting system elements further includes:
scanning a tag code on labels of the lighting system elements to tie the lighting system elements to lighting system element types and locations in the layout; and
transcribing the behaviors into the settings of the lighting system elements based on the lighting system element types and locations.

18. The non-transitory machine-readable of claim 11, wherein the programming the settings for the lighting system elements based on the lighting sequence of operation is implemented via the provisioning device.

19. The non-transitory machine-readable of claim 11, wherein the programming the settings for the lighting system elements based on the lighting sequence of operation is implemented via a gateway/edge device.

20. The non-transitory machine-readable of claim 11, wherein the network is a wired or wireless network.
